(19) United States
(12) Patent Application Publication
(10) Pub. No.: US 2007/0272308 A1
(43) Pub. Date: Nov. 29, 2007

(54) Check Valve With Oblong Hinge Openings

(76) Inventors: Wayne Spears, Sylmar, CA (US); Robert W. Spears, Sylmar, CA (US)

Correspondence Address: SHELDON MAK ROSE & ANDERSON PC, 100 East Corson Street, Third Floor, PASADENA, CA, 91103-3842, US

(21) Appl. No.: 11/420,178

(22) Filed: May 24, 2006

(51) Int. Cl. F16K 15/03

(52) U.S. Cl. 137/527.8

(57) ABSTRACT

(a) a body; (b) a valve seat; (c) a flapper; (d) a hinge pin attached to the body proximate to the valve seat and disposed substantially perpendicular to the fluid flow path; and (e) at least one flapper dog attached to the flapper, the flapper dog defining an aperture, the hinge pin being disposed through the aperture such that the flapper dog is rotatable around the hinge pin, the aperture in the flapper dog being oblong in shape.

### FIELD OF THE INVENTION

This invention relates generally to pipe fittings, and more specifically, to check valves.

### BACKGROUND OF THE INVENTION

Check valves are common pipe fitting components used to prevent the flow of fluids, especially liquids, in an undesired direction.

One of the most common types of check valves is a flapper-type check valve. In a flapper-type check valve, a flapper is hingedly retained within a valve body having a fluid flow path between an upstream opening and a downstream opening. The flapper is hingedly disposed within the body such that the flapper is alternatively moveable between (i) a closed position wherein the flapper mates with a valve seat within the body to essentially prevent the flow of fluids from the downstream opening to the upstream opening, and (ii) an open position wherein the flapper is not mated with the valve seat.

A problem with flapper-type check valves is that the flapper does not always mate securely with the valve seat, whereby fluids are allowed to flow from the downstream opening in the direction of the upstream opening.

Accordingly, there is a need for an improved flapper-type check valve which avoids the aforementioned problems in the prior art.

### SUMMARY

The invention satisfies this need. The invention is a check valve comprising (a) a body having a fluid flow path between an upstream opening and a downstream opening; (b) a valve seat disposed within the body and facing towards the downstream opening; (c) a flapper disposed within the body, the flapper being sized and dimensioned to mate with the valve seat to essentially prevent the flow of fluids from the downstream opening to the upstream opening; (d) a hinge pin attached to the body proximate to the valve seat and disposed substantially perpendicular to the fluid flow path, the hinge pin having a circular cross-section; and (e) at least one flapper dog attached to the flapper, the flapper dog defining an aperture, the hinge pin being disposed through the aperture such that the flapper dog is rotatable around the hinge pin and the flapper is alternatively moveable between (i) a closed position wherein the flapper mates with the valve seat to essentially prevent the flow of fluids from the downstream opening to the upstream opening, and (ii) an open position wherein the flapper is not mated with the valve seat, the aperture in the flapper dog being oblong in shape, defining a long dimension parallel to the fluid path and a short dimension perpendicular to the fluid flow path.

### DRAWINGS

These and other features, aspects and advantages of the present invention will become better understood with reference to the following description, appended claims and accompanying drawings where:

FIG. 1 is a perspective view of a check valve having features of the invention;

FIG. 2 is a cross-sectional side view of the check valve illustrated in FIG. 1;

FIG. 3 is a perspective view of a flapper useable in the check valve illustrated in FIG. 1;

FIG. 4 is a front view of the flapper illustrated in FIG. 3;

FIG. 5 is a cross-sectional side detail view of the flapper illustrated in FIG. 3; and

FIG. 6 is a magnified view of the upper portion of the flapper illustrated in FIG. 5.

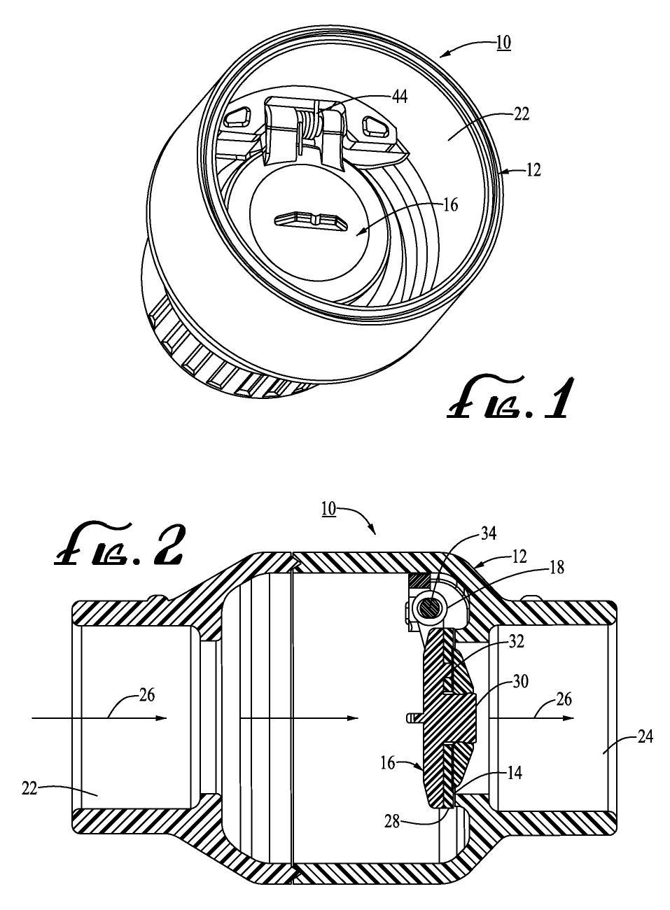

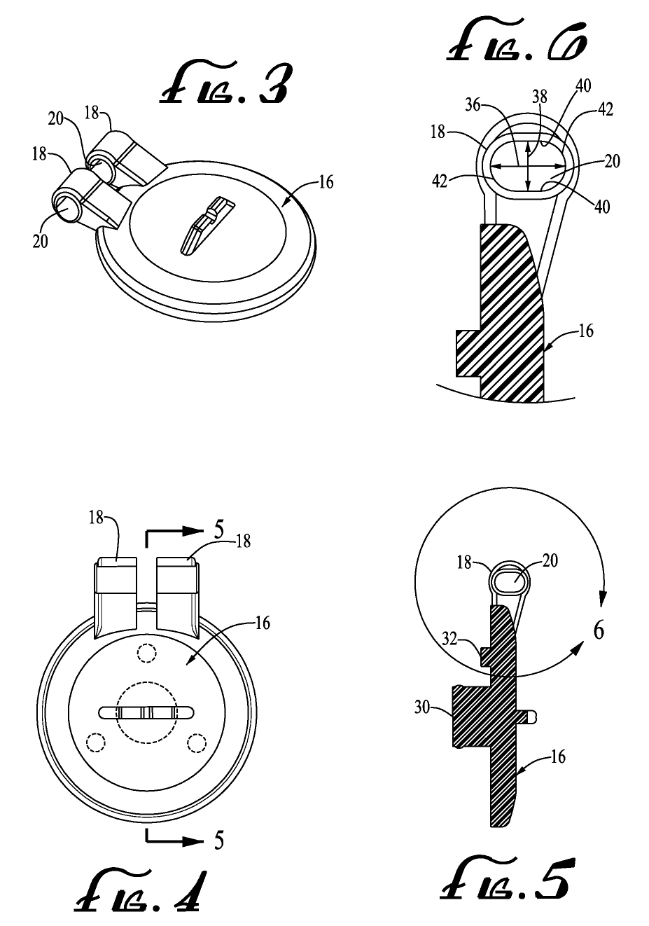

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a flapper-style check valve 10 comprising a body 12, a valve seat 14 and a flapper 16. The flapper 16 is hingedly disposed within the body 12 by one or more flapper dogs 18 having uniquely shaped flapper dog apertures 20 as described in detail below.

The body 12 can be made from any materials suitable for the service for which it is designed. Typically, the body 12 is made from a metal, such as steel, stainless steels, cast iron or brass or the body 12 is made from a plastic, such as PVC or CPVC.

The body 12 has an upstream opening 22 and a downstream opening 24 and defines a fluid flow path 26 between the upstream opening 22 and the downstream opening 24.

The valve seat 14 is disposed within the body 12 in an orientation facing towards the upstream opening 22.

The flapper 16 is disposed within the body 12. The flapper 16 is sized and dimensioned to mate with the valve seat 14 to essentially prevent the flow of fluids from the downstream opening 24 to the upstream opening 22.

Typically, a seal 28 is attached to the flapper 16 to facilitate the sealing of the flapper 16 to the valve seat 14 when the flapper 16 is in abutting, mating relationship with the valve seat 14. Typically, the seal 28 is made from a resilient material, such as a rubber or synthetic rubber. In the embodiment illustrated in the drawings, the seal 28 is affixed to the flapper valve with a central flapper knob 30 and an upper flapper projection 32.

A hinge pin 34 is attached to the body 12 proximate to the valve seat 14 and is disposed substantially perpendicular to the flow path 26. The hinge pin 34 has a circular cross section.

At least one flapper dog 18 is attached to the flapper 16, typically proximate to an edge of the flapper 16. When assembled within the body 12, the hinge pin 34 is disposed through the aperture 20 in the flapper dog such that the flapper dog is rotatable around the hinge pin 34 and the flapper 16 is alternatively moveable between (i) the closed position wherein the flapper 16 mates with the valve seat 14 to essentially prevent the flow of fluids from the downstream opening 24 to the upstream opening 22, and (ii) an open position wherein the flapper 16 is not mated with the valve seat 14.

In the embodiment illustrated in the drawing, the check valve 10 comprises a pair of opposed flapper dogs 18 rotatably attached to the hinge pin 34. Both of the flapper dogs 18 define an aperture 20 which is oblong in shape.

In the invention, the aperture 20 in the flapper dog 18 is oblong in shape, defining a long dimension 36 parallel to the fluid path and a short dimension 38 perpendicular to the fluid path.

As illustrated in the drawings, the oblong shape of the apertures 20 in the flapper dogs 18 have a pair of parallel long sides 40 and a pair of opposed arcuate ends 42. Also as illustrated in the drawings, the pair of arcuate ends 42 can be a pair of semi-circular ends.

The difference in the long dimension 36 and the short dimension 38 is at least as large as the manufacturing tolerances for the thickness of the seal 28. In a typical embodiment where the diameter of the hinge pin 34 is d, the long dimension 36 of the flapper dog 18 is between about 1.05 d and about 1.6 d. In such typical embodiments, the short dimension 38 is typically between about 1.01 d and about 1.1 d.

In the embodiment illustrated in the drawings, the check valve 10 further comprises an optional spring 44 which biases the flapper 16 towards the closed position.

The inventor has discovered that the slight increase in “play” in the interaction between the flapper dog 18 and the hinge pin 34 significantly increases the ability of the flapper 16 to properly mate with the valve seat 14. Although the reasons for this phenomenon are not fully understood, it is postulated that the slight increase in the ability of the flapper 16 to “wobble” about the hinge pin 34 compensates for small anomalies in the thickness of the seal 28 and/or in other manufacturing tolerances associated with the flapper valve and valve seat 14.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A check valve comprising:
(a) a body having a fluid flow path between an upstream opening and a downstream opening;
(b) a valve seat disposed within the body and facing towards the downstream opening;
(c) a flapper disposed within the body, the flapper being sized and dimensioned to mate with the valve seat to essentially prevent the flow of fluids from the downstream opening to the upstream opening;
(d) a hinge pin attached to the body proximate to the valve seat and disposed substantially perpendicular to the fluid flow path, the hinge pin having a circular cross-section; and
(e) at least one flapper dog attached to the flapper, the flapper dog defining an aperture, the hinge pin being disposed through the aperture such that the flapper dog is rotatable around the hinge pin and the flapper is alternatively moveable between (i) a closed position wherein the flapper mates with the valve seat to essentially prevent the flow of fluids from the downstream opening to the upstream opening, and (ii) an open position wherein the flapper is not mated with the valve seat, the aperture in the flapper dog being oblong in shape, defining a long dimension parallel to the fluid path and a short dimension perpendicular to the fluid flow path.

2. The check valve of claim 1 wherein the diameter of the hinge pin is d and the long dimension of the flapper dog aperture is between about 1.05 d and about 1.6 d.

3. The check valve of claim 1 wherein the diameter of the hinge pin is d and the short dimension of the flapper dog aperture is between about 1.01 d and about 1.1 d.

4. The check valve of claim 1 wherein the diameter of the hinge pin is d and the long dimension of the flapper dog aperture is between about 1.05 d and about 1.6 d, and wherein the diameter of the hinge pin is d and the short dimension of the flapper dog aperture is between about 1.01 d and about 1.1 d.

5. The check valve of claim 1 wherein the flapper dog aperture is defined by a pair of parallel long sides.

6. The check valve of claim 1 wherein the flapper dog aperture is defined by a pair of opposed arcuate ends.

7. The check valve of claim 1 wherein the flapper dog aperture is defined by a pair of semi-circular ends.

8. The check valve of claim 1 wherein the flapper dog aperture is defined by a pair of parallel long sides and a pair of opposed arcuate ends.

9. The check valve of claim 1 wherein the flapper dog aperture is defined by a pair of parallel long sides and a pair of opposed semi-circular ends.

10. The check valve of claim 1 further comprising a spring adapted to bias the flapper towards the closed position.
